(19) United States
(12) Patent Application Publication
(10) Pub. No.: US 2020/0298606 A1
(43) Pub. Date: Sep. 24, 2020

(54) MEDIUM INCLUDING THERMALLY EXPANSIVE LAYER AND PRODUCTION METHOD FOR MEDIUM INCLUDING THERMALLY EXPANSIVE LAYER

(71) Applicant: CASIO COMPUTER CO., LTD., Tokyo (JP)

(72) Inventor: Satoshi MITSUI, Tokyo (JP)

(73) Assignee: CASIO COMPUTER CO., LTD., Tokyo (JP)

(21) Appl. No.: 16/804,155

(22) Filed: Feb. 28, 2020

(30) Foreign Application Priority Data
Mar. 20, 2019 (JP) 2019-052917

(51) Int. Cl. B41M 5/36

(52) U.S. Cl. CPC B41M 5/36

(57) ABSTRACT

A medium includes
a base; and
a thermally expansive layer provided on the base, the thermally expansive layer including thermally expandable material,
wherein the thermally expansive layer further includes a porous material.

### CROSS-REFERENCE TO RELATED APPLICATION

This application claims the benefit of Japanese Patent Application No. 2019-052917, filed on Mar. 20, 2019, the entire disclosure of which is incorporated by reference herein.

### FIELD

This application relates to a medium including a thermally expansive layer that uses a thermally expandable material that foams and expands in accordance with an amount of heat absorbed and relates to a production method for the medium including the thermally expansive layer.

### BACKGROUND

A thermally expandable sheet that has a thermally expansive layer, which includes a thermally expandable material that foams and expands in accordance with an absorbed heat amount, formed on one side of a base sheet is conventionally known. Due to formation of a layer that converts light to heat on this thermally expandable sheet and irradiation this thermal conversion layer with light, the thermally expansive layer can be expanded in part or on the whole. Moreover, methods are known for formation of a shaped object having three-dimensional unevenness on a thermally expandable sheet causing a change of shape of the thermal conversion layer (for example, see Unexamined Japanese Patent Application Kokai Publication No. S64-28660 and Unexamined Japanese Patent Application Kokai Publication No. 2001-150812.

In conventional thermally expandable sheets, since heat from the layer for converting light to heat transfers to the surrounding area, this surrounding area may also expand. As a result, the outer edge portions (edges) of the portion caused to rise (convexity), due to the foaming of the thermally expandable material, becomes round which is problematic in that the outline of the convexity rises. For example, in the case where a protrusion is formed into a shape of a character, there is a problem in that the character becomes rather illegible due to, for example, the outline of the character becoming deformed or the entirety of the character becoming swollen.

In consideration of the aforementioned circumstances, an objective of the present disclosure is to provide a medium that includes a thermally expansive layer that can sharply form outer edge portions (edges) of convexities of the thermally expansive layer and to provide a method of producing the medium that includes the thermally expansive layer.

### SUMMARY

A medium including:

a base; and

a thermally expansive layer provided on the base, the thermally expansive layer including thermally expandable material,

wherein the thermally expansive layer further includes a porous material.

A method of producing a medium including a thermally expansive layer, the method including:

forming a thermally expansive layer including thermally expandable material on a base,

wherein porous material is added to the thermally expansive layer.

The present disclosure can provide a medium including a thermally expansive layer enabling outer edge portions of convexities of the thermally expansive layer to be sharply formed and provide a method for producing the medium including the thermally expansive layer.

### BRIEF DESCRIPTION OF THE DRAWINGS

A more complete understanding of this application can be obtained when the following detailed description is considered in conjunction with the following drawings, in which:

FIG. 1 is a cross-sectional view illustrating an overview of a thermally expandable sheet according to an embodiment;

FIG. 2A is a diagram demonstrating a production method of the thermally expandable sheet according to the embodiment;

FIG. 2B is another diagram demonstrating the production method of the thermally expandable sheet according to the embodiment;

FIG. 2C is yet another diagram demonstrating the production method of the thermally expandable sheet according to the embodiment;

FIG. 3 is a flowchart demonstrating a production method of a shaped object according to the embodiment;

FIG. 4A is a cross-sectional view demonstrating the production method of the shaped object according to the embodiment;

FIG. 4B is another cross-sectional view demonstrating the production method of the shaped object according to the embodiment;

FIG. 5 is a diagram illustrating an overview of an expansion device;

FIG. 6A is a diagram demonstrating a convexity of a thermally expansive layer of a conventional example;

FIG. 6B is a diagram demonstrating a convexity of a thermally expansive layer according to the embodiment;

FIG. 7 is a diagram illustrating a portion for which the height of the convexity of the thermally expandable sheet according to an implemented example is measured;

FIG. 8A is diagram illustrating the height of the convexity of the thermally expandable sheet according to the implemented example; and

FIG. 8B is a diagram illustrating the height of a thermally expandable sheet according to a comparison example.

### DETAILED DESCRIPTION

A medium including a thermally expansive layer and method for producing the medium including the thermally expansive layer according to the present embodiment are described in detail below with reference to the drawings.

In the present embodiment, a thermally expandable sheet 20 having a base 21 that is a sheet-type is described as an example of a medium 10 that includes a thermally expansive layer.

In the embodiment, a shaped object is expressed on a surface by the rising of a thermally expansive layer 22 on a top surface of the medium 10. Also, in the present disclosure, the term “shaped object” broadly includes shapes such as simple shapes, geometrical shapes, characters, decorations, or the like. The term “decorations” refers to objects that appeal to the aesthetic sense through visual and/or tactile sensation. The term “shaping” (or forming) is not limited to the simple formation of the shaped object but rather is to be construed to also include concepts such as decorating and ornamenting. Further, the term “decorative shaped object” indicates a shaped object formed as a result of decoration or ornamentation.

The shaped object of the present embodiment has unevenness in a direction, such as the Z-axis direction, perpendicular to a standard surface taken to be a two-dimensional surface, such as the XY plane, within a three-dimensional space. Although such a shaped object is one example of a three-dimensional (3D) image, to distinguish this three-dimensional image from three-dimensional images formed using so-called 3D printer technology, the shaped object is called a 2.5-dimensional (2.5D) image or a pseudo-three-dimensional (pseudo-3D) image.

Thermally Expandable Sheet 20

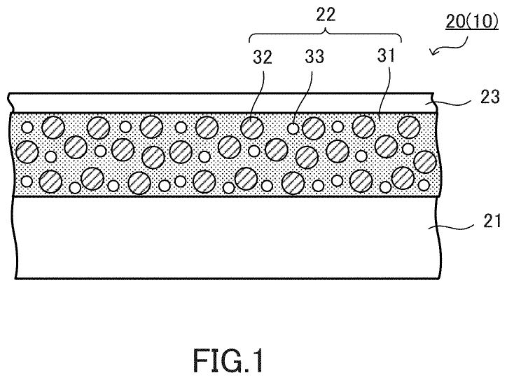

The thermally expandable sheet 20, as illustrated in FIG. 1, includes the base 21, the thermally expansive layer 22, and an ink receiving layer 23.

The base (base body) 21 is a sheet-like member for support of the thermally expansive layer 22 and the like. The thermally expansive layer 22 is provided on a surface (the front surface; the top surface in FIG. 1) of the base 21. Paper such as high-quality paper, or a sheet (including films) made from a resin such as polyethylene terephthalate (PET) is used as the base 21. The paper is not limited to a sheet made from PET, and any known sheet can be used. Additionally, the resin is not limited to PET, and any resin can be used. Without particular limitation, examples of the resins include materials selected from polyolefin resins such as polyethylene (PE) and polypropylene (PP), polyethylene terephthalate (PET), polyethylene naphthalate (PEN), and polybutylene terephthalate (PBT), polyester resins, polyamide resins such as nylon, polyvinyl chloride (PVC) resins, polystyrene (PS), polyimide resins, silicone resins, and the like.

The base 21 is provided with sufficient strength such that, when the thermally expansive layer 22 distends in part or on the whole due to foaming, the opposite side of the base 21 (the underside illustrated in FIG. 1) does not rise. Moreover, the base 21 is provided with sufficient strength such that, during expansion of the thermally expansive layer 22, shape as a sheet is not lost by generation of winkles, formation of large undulations, or the like. In addition, the base 21 has sufficient heat resistance so as to withstand heat during foaming of the thermally expansive layer 22. The base 21 may further have elasticity and the base 21 may deform in accordance with the distension of the thermally expansive layer 22, and the deformed shape of the base 21 may be maintained after the distension of the thermally expansive layer 22.

The thermally expansive layer 22 is provided on a first side (the top surface in FIG. 1) of the base 21. The thermally expansive layer 22 is a layer that distends in size in accordance with a degree of heating (such as a heating temperature or a heating period). The thermally expansive layer 22 includes binder 31, thermally expandable material (thermally-expandable microcapsules, micropowder) 32, and porous material 33. The thermally expandable material 32 and the porous material 33 are dispersed in the binder 31. The thermally expansive layer 22 is not limited to a single layer. The thermally expansive layer 22 may include multiple layers that contain the thermally expandable material 32. Moreover, the thermally expansive layer 22 may be formed by staking these layers. The thermally expansive layer 22 is provided with a thickness of, for example, 50 μm to 500 μm. Preferably, the thermally expansive layer 22 is provided with a thickness of 80 μm to 200 μm.

Any thermoplastic resin, such as an ethylene-vinyl acetate polymer or an acrylic polymer, may be used as the binder 31 of the thermally expansive layer 22. Also, the thermally expandable material 32 encapsulates propane, butane, or another low boiling point substance inside shells of the thermoplastic resin. The shells are formed from a thermoplastic resin such as, for example, polystyrene, polyvinyl chloride, polyvinylidene chloride, polyvinyl acetate, polyacrylic acid ester, polyacrylonitrile, polybutadiene, and copolymers thereof. Average particle size of the thermally expandable material 32 is about 5 μm to 50 μm, for example. When the thermally expandable material is heated to at least the temperature at which expansion begins, the shells made of resin soften, and the encapsulated low-boiling point volatile substance volatilizes, causing the shells to expand due to pressure in a balloon-like manner. Although dependent on characteristics of the used thermally expandable material 32, the particle size of the thermally expandable material 32 after expansion increases to about five times the size prior to expansion. Further, variance exists in the particle size of the thermally expandable material 32. Note that, while diagrams such as FIG. 1 illustrate the particle size of the thermally expandable material 32 as being substantially uniform, not all particles have the same size. That is, there is variation in the particle size of the thermally expandable material 32.

The porous material 33 is a material that includes fine pores. The material includes porous silica, porous ceramic (porous alumina, for example), and the like. One type or multiple types may be used as the porous material 33. In the present embodiment, with the inclusion of the porous material 33 in the thermally expansive layer 22, as described in detail further below, the edges of the swollen portions (convexity 22a) of the thermally expansive layer 22 can be sharpened.

In the thermally expansive layer 22, although not limiting, it is preferable that the weight of the thermally expandable material 32 with respect to the total weight of the binder 31, the thermally expandable material 32, and the porous material 33 is 20 wt % to 60 wt %. Moreover, it is preferable that the weight of the porous material 33 with respect to the total weight of the binder 31, thermally expandable material 32 and the porous material 33 is no less than 15 wt %, and that the weight of the porous material 33 is no greater than the binder 31 is wt % total weight of the binder 31, the thermally expandable material 32, and the porous material 33. For example, the weight ratio of the binder 31 to the thermally expandable material 32 to the porous material 33 is 1:3:1.

The ink receiving layer 23 can be provided on the thermally expansive layer 22. The ink receiving layer 23 is a for layer receiving and holding ink used in a printing step such as water-based ink of an inkjet printer. The ink receiving layer 23 is formed using a known material according to the type of ink to be used in the printing step. In a case where voids are to be used to receive ink, the ink receiving layer 23 includes porous silica, for example. In a case where the ink receiving layer 23 is to receive ink while being swollen, the ink receiving layer 23, the ink receiving layer 23 includes a resin selected from, for example, polyvinyl alcohol (PVA) resin, a polyester resin, a polyurethane resin, an acrylic resin, and the like.

The ink receiving layer 23 may be omitted. For example, in a case where printing is to be performed with use of, for example, ultraviolet curable ink, the ink receiving layer 23 may be omitted. Additionally, since the thermally expansive layer 22 of the present embodiment includes the porous material 33 as described above, the thermally expansive layer 22 can be made to serve as an ink receiving layer. In this case as well, the ink receiving layer 23 may be omitted.

In the present embodiment, an electromagnetic wave thermal conversion layer (hereinafter also referred to simply as “thermal conversion layer” or “conversion layer”) for converting that converts electromagnetic waves into heat is provided on the top surface (front surface) of the thermally expandable sheet 20, and is irradiated with electromagnetic waves to cause the thermal conversion layer to generate heat. The thermal conversion layer is heated due to being irradiated with electromagnetic waves and, as such, is also called a “heated layer.” The heat generated by the thermal conversion layer provided on the front surface of the thermally expandable sheet 20 is transmitted to the thermally expansive layer 22. As a result, the thermally expandable material in the thermally expansive layer 22 foams and distends. The electromagnetic waves are converted to heat more quickly where the thermal conversion layer is provided than in other regions where the thermal conversion layer is not provided. As such, the regions in close proximity to the thermal conversion layer can be exclusively and selectively heated, and specific regions of the thermally expansive layer 22 can be exclusively and selectively caused to distend. The thermal conversion layer may be provided on the bottom surface (back surface) or may be provided on the top surface and the bottom surface.

Production Method of Thermally Expandable Sheet

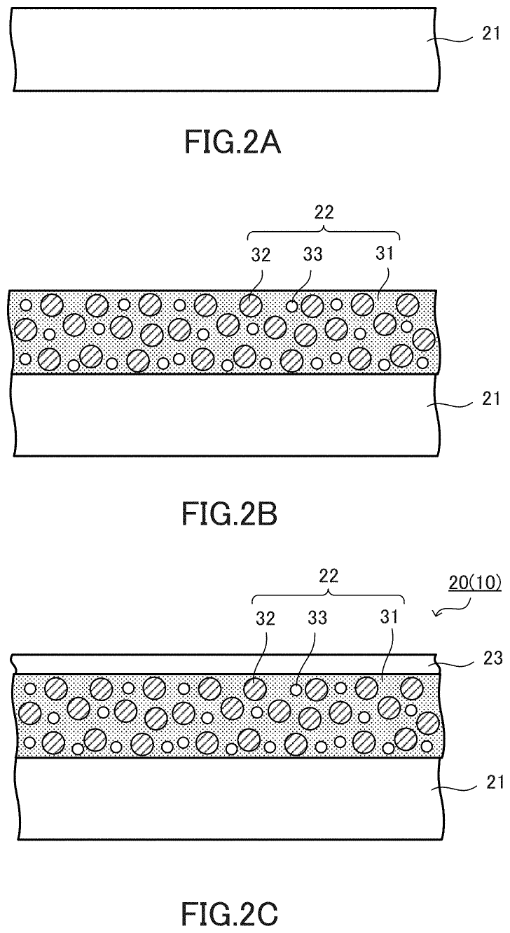

Next, a production method of the thermally expandable sheet 20 is described with reference to FIG. 2A to FIG. 2C.

First, the base (base body) 21 is prepared (FIG. 2A). For example, a roll of paper is used as the base 21. However, the manufacturing method described further below is not limited to a roll, and an individual sheet may be used.

Next, the aforementioned binder 31, the thermally expandable material 32, and the porous material 33 are used in a known dispersion device or the like to prepare a coating liquid for forming the thermally expansive layer 22. Subsequently, the coating liquid is applied on one of the surfaces of the base 21 using a known coating device such as a bar coater, roller coater, or a spray coater. Subsequently, the coating is dried, thereby forming the thermally expansive layer 22 as illustrated in FIG. 2B. Both the application and the drying of the coating liquid may be repeated multiple times in order to obtain a target thickness of the thermally expansive layer 22. Moreover, the thermally expansive layer 22 may be formed by use of a printing device or the like.

Next, a coating liquid is prepared using the material of the aforementioned ink receiving layer 23. Subsequently, the liquid is applied on the thermally expansive layer 22 using a known application device such as the bar coater, the roller coater, or the spray coater. Both the application and the drying of the coating liquid may be repeated multiple times in order to obtain a target thickness of the ink receiving layer 23. Subsequently, the coating is dried, thereby forming the ink receiving layer 23 as illustrated in FIG. 2C. Moreover, the ink receiving layer 23 may be formed by use of a printing device or the like.

In a case where the base 21 is in roll-form, cutting is performed as necessary to obtain the thermally expandable sheet 20.

The thermally expandable sheet 20 is produced by the steps described above.

Production Method of Shaped Object

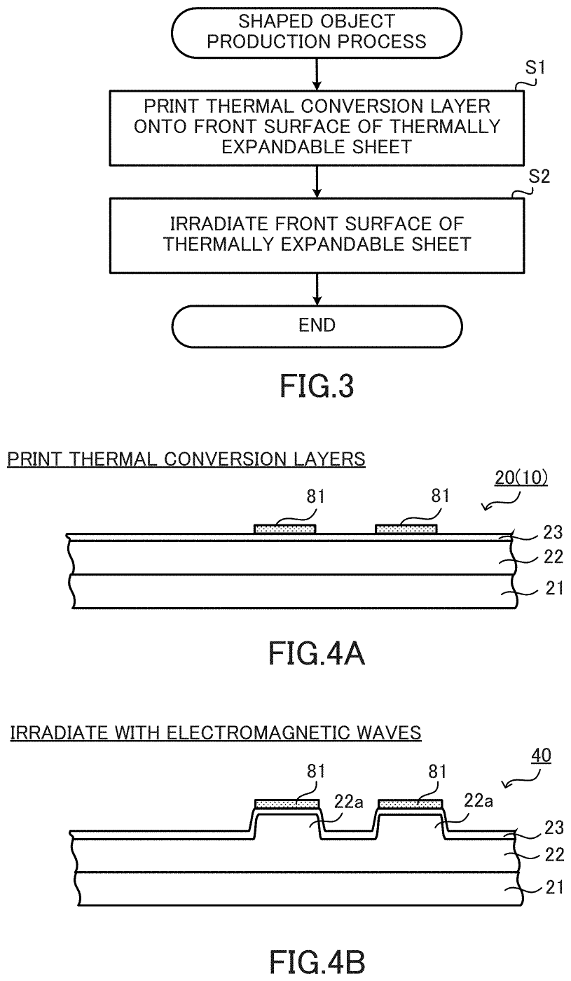

Next, the flow of the process for producing the shaped object 40 using the thermally expandable sheet 20 is described with reference to the flowchart illustrated in FIG. 3, the cross-sectional views of the thermally expandable sheet 20 illustrated in FIG. 4A and FIG. 4B.

First, the thermally expandable sheet 20 is prepared. Foaming data (data corresponding thermal conversion layer 81) indicating the portion to be foamed in the front surface of the thermally expandable sheet 20 and caused to distend is determined in advance. Next, the printing device is used to print a thermal conversion layer 81 onto the front surface of the thermally expandable sheet 20 (step S1). The thermal conversion layer 81 is a layer formed by foamable ink that includes the electromagnetic wave thermal conversion material. The layer is formed by a foamable ink that includes carbon black, cesium tungsten oxide, or LaB₆. The printing device prints on the front surface of the thermally expandable sheet 20 using the foamable ink. The printing is performed in accordance with the designated foaming data. As a result, the thermal conversion layer 81 is formed on the front surface of the thermally expandable sheet 20 as illustrated in FIG. 4A. When the thermal conversion layer 81 is printed darkly, the amount of heat generated increases and, as a result, the thermally expansive layer 22 rises higher. Accordingly, the deformation height of the thermally expansive layer 22 can be controlled by controlling the density of the thermal conversion layer 81.

Second, the thermally expandable sheet 20 onto which the thermal conversion layer 81 is printed is transported to the expansion device an expansion device 50 such that the front surface of the thermally expandable sheet 20 faces upward and then the thermal conversion layer 81 is irradiated with electromagnetic waves causing the thermally expansive layer 22 to distend (step S2).

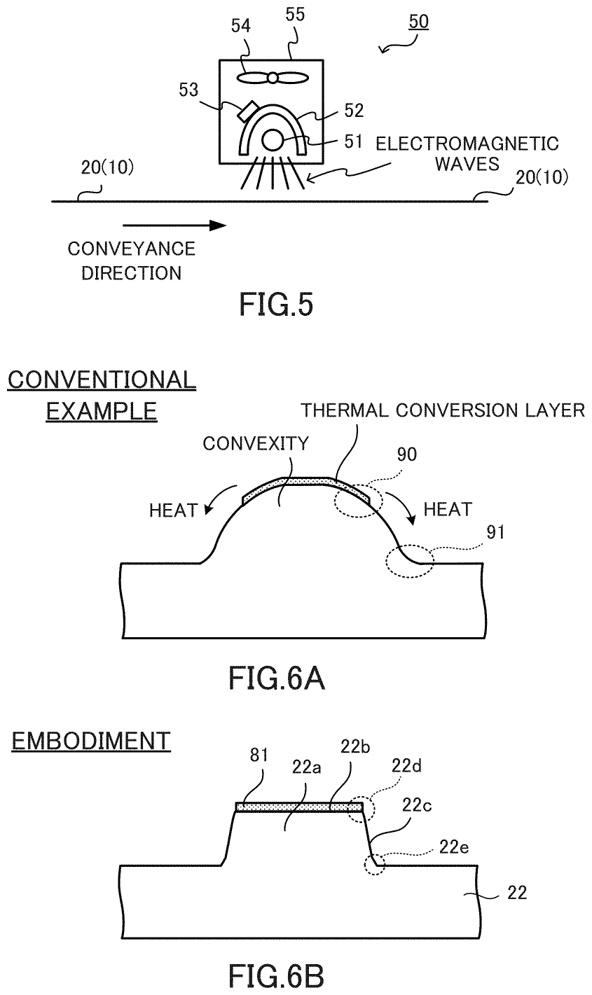

Specifically, the expansion device 50, as illustrated in FIG. 5, includes a lamp heater, a reflection plate 52 that reflects the electromagnetic waves emitted from the irradiation unit 51 toward the thermally expandable sheet 20, a temperature sensor 53 that measures the temperature of the reflection plate 52, and a cooler 54 that cools the interior of the expansion device 50, a pair of conveying rollers that hold therebetween the thermally expandable sheet 20 for conveyance along a conveyance guide, and a conveying motor for rotating the pair of conveying rollers. Also, the irradiation unit 51, the reflection plate 52, the temperature sensor 53, and the cooler 54 are housed within a housing 55. The pair of conveying rollers conveys the thermally expandable sheet 20 to underneath the irradiation unit 51.

The lamp heater, for example, includes a halogen lamp, and the lamp heater irradiates the thermally expandable sheet 20 with the electromagnetic waves (light) in the near-infrared region (750 to 1,400 nm wavelength range), the visible light region (380 to 750 nm wavelength range), or the intermediate infrared region (1,400 to 4,000 nm wavelength range). The irradiation unit 51 is not limited to a halogen lamp, and a different configuration may be used as long as irradiation with the electromagnetic waves can be performed. Moreover, the wavelength of the electromagnetic waves is not limited to the aforementioned ranges.

The thermally expandable sheet 20 printed with the thermal conversion layers 81 illustrated in FIG. 4A is conveyed toward the expansion device 50 with the front surface face upward. At the expansion device 50, the front surface of the thermally expandable sheet 20 is irradiated with the electromagnetic waves by the irradiation unit 51. In the parts where the thermal conversion layers 81 are formed, the electromagnetic waves are converted to heat with greater efficiency in comparison to the parts where the thermal conversion layers 81 are not provided. Thus within the thermally expandable sheet 20, parts where the thermal conversion layers 81 are formed are mainly heated, and, when the temperature at which expansion begins is reached, the thermally expandable material expands. As a result, the thermally expansive layer 22 in the regions where the thermal conversion layers 81 are formed expand and convexities 22a are formed as illustrated in FIG. 4B.

The shaped object 40 is produced using the thermally expandable sheet 20 as a result of execution of the procedure described above.

Since the thermally expansive layer does not include porous material in the conventional example, the heat from the thermal conversion layer also transfers to the area surrounding the thermal conversion layer. As a consequence of this, the thermally expandable material in the area surrounding the thermal conversion layer also expands. As a result, the region (portion of 90 illustrated in FIG. 6A) in close proximity to the thermal conversion layer extensively expands, and portions in contact with the outer edge portions, not forming as corners, also become rounded in shape instead. Also, the angle of inclination of the side surfaces of the convexity have is smooth in comparison with that of the embodiment. Additionally, the portion near the bottom end of the convexity (portion of 91 illustrated in FIG. 6A) also gently rises. Therefore, the convexity in the conventional example becomes swollen in shape extending outwards into the surrounding area. Thus, the outline becomes blurred. This is especially problematic in a case where the convexity is formed into the shape of a character because the resolution decreases.

In contrast to this, according to the present embodiment, the inclusion of the porous material 33 in the thermally expansive layer 22 enables the outer edge portions (edges) of the portion that were caused to distend (convexity 22a) to be sharply formed. Specifically, air can be easily contained within the porous material 33 included in the thermally expansive layer 22. Therefore, it is assumedly easier to suppress or prevent heat, generated by the thermal conversion layer 81, from transferring in the direction outward from the thermal conversion layer 81. As a result, the transfer of heat to region surrounding the thermal conversion layer 81 is suppressed or prevented and as illustrated in FIG. 6B, the area directly underneath the thermal conversion layer 81 and the region in close proximity to the thermal conversion layer 81 distends on the thermally expansive layer 22, thereby forming the convexity 22a. At this point in time, the angle of inclination of the side surface 22c of the convexity 22a is more vertical than that in the conventional example illustrated in FIG. 6A. Therefore, a top end (outer edge portion) 22d is formed when an upper surface 22b and the side surface 22c of the convexity 22a, easily coming in contact with each other, together form a corner. Also, since the angle of inclination of the side surface 22c of the convexity 22a is more vertical than that in the conventional example, a bottom end 22e illustrated in FIG. 6B clearly is more distinctly formed. Since the shape of the convexity 22a is generated by the distension of the thermally expandable material 32, the corners generated by the upper surface 22b and the side surface 22c of the convexity 22a also include round corners.

With the convexity 22a of the present embodiment being provided with this top end 22d which has a corner, the outer edge portion (top end 22d) of the convexity 22a can be sharply formed. Also, the outline of the convexity 22a becomes distinctly recognizable. Moreover, the resolution of the shaped object 40 can be enhanced.

### Implemented Example

With paper being used as the base, a sheet including a thermally expansive layer on the paper was prepared as the thermally expandable sheet according to the implemented example. Binder, thermally expandable material, and porous material, in a 1:3:1 weight ratio, were included in the thermally expansive layer. Wet silica (porous silica) was used as the porous material. Also, as a comparison example, a thermally expandable sheet including a thermally expansive layer not having porous material was prepared. Binder and thermally expandable material, in a 1:1 weight ratio, were included in the thermally expansive layer. In both the embodiment and the implemented example, the same material is used for the binder and the thickness of the base and the thickness of the thermally expansive layer are the same.

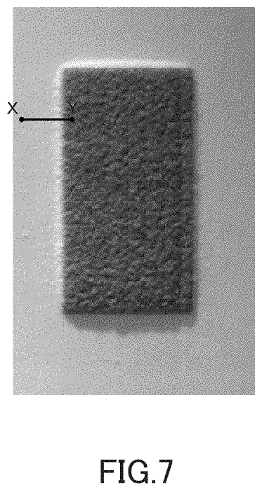

An inkjet printer and ink including carbon black were used to print a rectangular-shaped thermal conversion layer onto a thermally expandable sheet of the implemented example. Next, the thermal conversion layer was irradiated with electromagnetic waves. This caused the thermally expansive layer to distend, thereby forming a convexity. Under the same conditions, a convexity was also formed on the thermally expandable sheet of the comparison example by causing the thermally expansive layer to distend. Also, the height of the end of the convexity of the thermally expandable sheet of the comparison example and the height of area in close proximity to the convexity were measured using a laser scan. The measurement portion is illustrated in FIG. 7. The measurement portion is the X-Y line illustrated in FIG. 7. The left end X is referred to as the reference point. For the comparison example, the height of the same portion as that in the implemented example was also measured. In the comparison example, the measurement was performed up to the position where the height is greatest since the swelling is gradual as described further below.

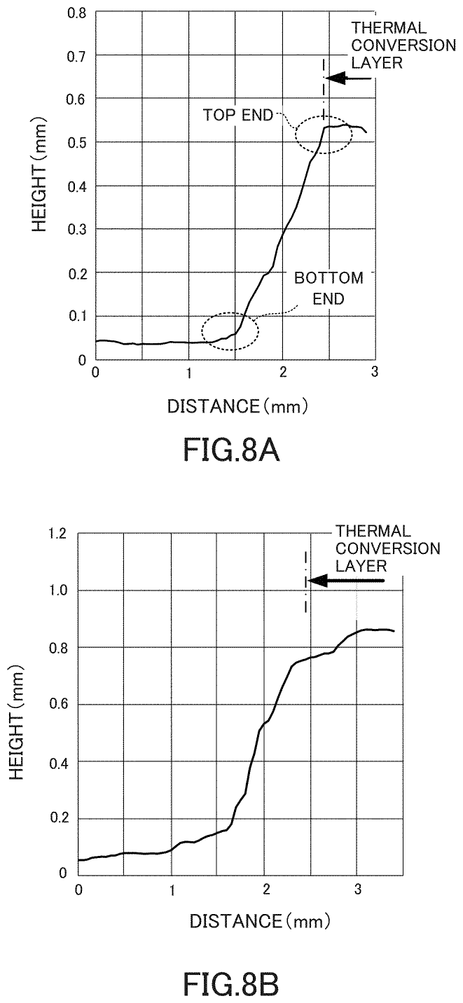

The measurement result of the height of the convexity of the thermal expandable sheet according to the implemented example is illustrated in FIG. 8A. The horizontal axis in FIG. 8A represents distance (mm) from a reference point disposed in a region where the thermally expandable sheet is not distended and the vertical axis represents height (mm). As illustrated in FIG. 8A, at the thermally expandable sheet of the implemented example, the end of the thermal conversion layer is at a position of 2.4 mm from the reference point and the portion indicated by the arrow in FIG. 8A is where the thermal conversion layer is formed. The convexity begins to rise from a position of 1.5 mm from the reference point, gradually increasing in height up to the end portion of the thermal conversion layer. The distension height of the region where the thermal conversion layer is formed is highest in height and the end portion of the thermal conversion layer is where the corner is created (portion of the top end of the thermal conversion layer illustrated in FIG. 8A). Additionally, no rising occurs in the area in close proximity to the reference point and height from the reference point up to the position 1.5 mm from the reference point is substantially the same. Therefore, there is a distinct demarcation between the region where no rising occurs and the portion where rising begins, and thus a shape having a corner, such as the portion near the bottom end illustrated in FIG. 8A, is formed.

In contrast to this, in the comparison example, as illustrated in FIG. 8B, bulging also occurs in the area in close proximity to the reference point, and this bulging around the entirety of the thermal expansion layer gradually increases toward the thermal expansion layer. Moreover, since end portions of the thermal conversion layer are not formed into distinct corners or the like, and instead the shape is such that there is curving all the way around.

It was confirmed that the angle of inclination of a side of a convexity with the configuration of the implemented example illustrated in FIG. 8A is more vertical than that in the comparison example illustrated in FIG. 8B. It was also confirmed that the angled upper-end (outer edge portion) was formed with the configuration of the implemented example.

This application is not limited to the embodiments described above and various modifications and uses are possible. For example, although a medium provided with a thermally expansive layer in the embodiment described above is described as being a sheet-type, this is not limiting. For example, the thermally expansive layer 22 may be provided on, for example, a base whose surface has a convexity and/or a concavity. The base 21 is not limited to the sheet-type, and it may be more thickly formed. Additionally, the base 21 may have a curved surface and the front surface of the base 21 may have unevenness. In such a case, the step of forming the thermally expansive layer 22 may be modifying in accordance with the shape of the base 21.

A shaped object 40 may be provided with color ink layer (not illustrated) on at least one of the surfaces (the front surface or the back surface illustrated in FIG. 4A). The color ink layer is a layer formed from ink using a freely selected printing device such as an offset printing device or a flexographic printing device. The color ink layer may be formed from a water-based ink, an oil-based ink, an ultraviolet-curing type ink, or the like. Moreover, the color ink layer expresses a desired image such as characters, numbers, photographs, patterns, or the like. When the color ink layer is to be formed using a water-based ink jet printer, preferably, an ink receiving layer (non-illustrated) is provided that receives the ink on the surface where the color ink layer is to be formed, and then the color ink layer is formed.

Also, the thermal conversion layer 81 may be formed on the back-side surface of the thermally expandable sheet 20 or may be formed on the front side and the back side. Moreover, the case in which the surface on which the thermal conversion layer 81 is formed is irradiated with the electromagnetic waves is not limiting, and the side opposite to the surface on which the thermal conversion layer 81 is formed may be irradiated with the electromagnetic waves.

Also, the direct formation of the thermal conversion layer 81 on the thermally expandable sheet 20 is not limiting, and such formation may be performed with an intermediary such as a film provided therebetween.

Also, the expansion device 50 is not limited to a stand-alone configuration as illustrated in FIG. 5. For example, a forming system equipped with a control unit, a printing unit, a display unit, and the like in addition to the expansion device 50 can also be used. The control unit is equipped with parts such as a controller that has components such as a central processing unit (CPU), and controls the expansion device 50, the printing unit, the display unit, or the like. The printing unit is a known printing apparatus such as an inkjet printer. The display unit is a liquid crystal panel, a touch panel, or the like.

In the above described embodiments, although an example is given where the step of forming the thermal conversion layer 81 is performed when the shaped object 40 is to be produced but this, this is not limiting. The thermal conversion layer 81 maybe formed when the thermally expandable sheet 20 is to be produced, and during the method for production of the shaped object, and a single step of expanding with use of the expansion device may be performed. Furthermore, the production of the thermally expandable sheet 20 illustrated in FIG. 2A to FIG. 2C and the production of the shaped object 40 illustrated in FIG. 4A and FIG. 4B may be combined and performed together.

Although the thermal conversion layer or the color ink layer, depending on factors such as the type of the image to be printed or the method of printing, might not form a distinct layer, the expression “layer” as in “thermal conversion layer” and “color ink layer” is used in the present description for each of description.

Moreover, the drawings used in the various embodiments are each used for description of the embodiments. Thus there is no intent for ratios of thicknesses of the various formed layers of the thermally expandable sheet to be construed as being limited to the ratios illustrated in the drawings. Moreover, in the drawings used in the various embodiments, thickness of the thermal conversion layer or the like that is provided on the thermally expandable sheet is emphasized for the sake of description. Accordingly, the ratios of the thicknesses at which the heat conversion layer or the like is formed are not intended to be construed as limiting.

The foregoing describes some example embodiment for explanatory purposes. Although the foregoing discussion has presented specific embodiment, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A medium comprising:
a base; and
a thermally expansive layer provided on the base, the thermally expansive layer including thermally expandable material,
wherein the thermally expansive layer further includes a porous material.

2. The medium according to claim 1, wherein the porous material includes at least one of porous silica or porous ceramic.

3. The medium according to claim 1, wherein
the thermally expansive layer further includes binder,
the thermally expandable material from 20 wt % to 60 wt % with respect to a total weight of the binder, the thermally expandable material, and the porous material is included, and
the porous material greater than or equal to 15 wt % with respect to the total weight of the binder, the thermally expandable material, and the porous material and less than or equal to the binder wt % is included.

4. The medium according to claim 1, wherein a weight ratio of the binder to the thermally expandable material to the porous material is 1:3:1.

5. The medium according to claim 1, further comprising an ink receiving layer atop the thermally expansive layer.

6. The medium according to claim 3, wherein the binder is a thermoplastic resin.

7. The medium according to claim 1, wherein the thermally expansive layer has a thickness of 50 μm to 500 μm.

8. A method of producing a medium including a thermally expansive layer, the method comprising:
forming a thermally expansive layer including thermally expandable material on a base,
wherein porous material is added to the thermally expansive layer.

9. The method of producing the medium including the thermally expansive layer according to claim 8, wherein the porous material includes at least one of porous silica or porous ceramic.

10. The method of producing the medium including the thermally expansive layer according to claim 8,
wherein
the thermally expansive layer is formed by mixing the thermally expandable material and the porous material together with binder,
the thermally expandable material from 20 wt % to 60 wt % with respect to a total weight of the binder, the thermally expandable material, and the porous material is included, and
the porous material greater than or equal to 15 wt % with respect to the total weight of the binder, the thermally expandable material, and the porous material and less than or equal to the binder wt % is included.

11. The method of producing the medium including the thermally expansive layer according to claim 10, wherein a weight ratio of the binder to the thermally expandable material to the porous material is 1:3:1.

12. The method of producing the medium including the thermally expansive layer according to claim 8, further comprising:
forming, on the thermally expansive layer, an ink receiving layer for receiving ink.

13. The method of producing the medium including the thermally expansive layer according to claim 10, wherein the binder is a thermoplastic resin.

14. The method of producing the medium including the thermally expansive layer according to claim 13, wherein the thermally expansive layer is formed to a thickness of 50 μm to 500 μm.
